(19) United States
(12) Patent Application Publication
(10) Pub. No.: US 2019/0366979 A1
(43) Pub. Date: Dec. 5, 2019

(54) MANAGEMENT SERVER, MANAGEMENT SYSTEM, AND MANAGEMENT METHOD

(71) Applicant: HONDA MOTOR CO., LTD., Tokyo (JP)

(72) Inventors: Megumi YANAGA, Wako-shi (JP); Jun OHASHI, Wako-shi (JP)

(21) Appl. No.: 16/423,739

(22) Filed: May 28, 2019

(30) Foreign Application Priority Data
Jun. 4, 2018 (JP) 2018-107128

(51) Int. Cl. B60R 25/24; G06Q 30/06; B60R 25/20; B60R 25/01

(52) U.S. Cl. CPC B60R 25/24; B60R 25/01; B60R 25/2018; G06Q 30/0645

(57) ABSTRACT

A management server manages a vehicle. The server includes: a receiving unit configured to receive a usage request for the vehicle from a user terminal of a renter; and a sending unit configured to send, to the user terminal, a virtual key that enables the vehicle to be used. The virtual key is a key that permits a door of the vehicle to be unlocked and permits the renter to enter the vehicle, and prohibits at least some of other functions of the vehicle from being used.

### CROSS-REFERENCE TO RELATED APPLICATION(S)

This application claims priority to and the benefit of Japanese Patent Application No. 2018-107128 filed on Jun. 4, 2018, the entire disclosure of which is incorporated herein by reference.

### BACKGROUND OF THE INVENTION

### Field of the Invention

The present invention relates to a management server, a management system, and a management method.

### Description of the Related Art

A system in which a vehicle owner registers a period in which he/she will not use the vehicle as a rentable period for the vehicle, and the vehicle is then rented by the hour, has been proposed. For example, International Publication No. WO 2013/099964 discloses a technique in which, for example, a vehicle owner registers a period in which he/she will not use the vehicle as a rentable period for the vehicle, and the vehicle is then rented by the hour, as a way of making effective use of supplier resources.

However, vehicle users sometimes wish only to use the cabin of a parked vehicle, e.g. to listen to music or to rest, rather than driving the vehicle. In such a case, the likelihood that problems with renting out the vehicle, such as vehicle theft and accidents while traveling, will arise can be reduced, and the vehicle's owner can therefore permit the vehicle to be rented without hesitation.

### SUMMARY OF THE INVENTION

An object of the present invention is to provide a technique for enabling cabin space of a vehicle to be rented out to a third party.

According to one aspect of the present invention, a management server that manages a vehicle, the server comprising: a receiving unit configured to receive a usage request for the vehicle from a user terminal of a renter; and a sending unit configured to send, to the user terminal, a virtual key that enables the vehicle to be used, wherein the virtual key is a key that permits a door of the vehicle to be unlocked and permits the renter to enter the vehicle, and prohibits at least some of other functions of the vehicle from being used.

Further features of the present invention will become apparent from the following description of exemplary embodiments with reference to the attached drawings.

### BRIEF DESCRIPTION OF THE DRAWINGS

FIG. 1 is a diagram illustrating a management system according to an embodiment.

FIG. 2 is a block diagram illustrating a vehicle according to the embodiment.

FIG. 3 is a block diagram illustrating a management server according to the embodiment.

FIG. 4 is a block diagram illustrating a user terminal according to the embodiment.

FIG. 5 is a diagram illustrating an example of vehicle information stored in a vehicle information database of the management server according to the embodiment.

FIG. 6 is a diagram illustrating a processing sequence carried out by the management system according to a first embodiment.

FIG. 7 is a diagram illustrating a processing sequence carried out by the management system according to a second embodiment.

FIG. 8 is a diagram illustrating a processing sequence carried out by the management system according to a third embodiment.

### DESCRIPTION OF THE EMBODIMENTS

Embodiments of the present invention will be described hereinafter with reference to the drawings.

### First Embodiment

The present embodiment provides a system in which a usage request is accepted from a user terminal of the user requesting the use of vehicle cabin space, and a virtual key for the vehicle is sent to the user terminal when it is determined that the user is to be permitted to use the vehicle cabin space.

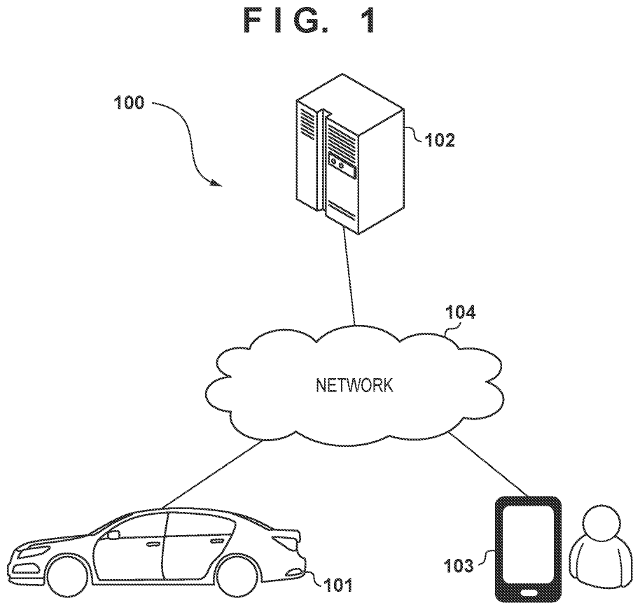

A management system according to the present embodiment will be described with reference to FIG. 1. A management system 100 includes a vehicle 101 and a management server 102. The vehicle 101 and the management server 102 are communicatively connected over a communication network 104. A user terminal 103, which can communicate with the vehicle 101 and the management server 102, is also connected to the communication network 104.

The vehicle 101 is a vehicle that is managed by the management server 102, and a door of the vehicle 101 can be unlocked by a virtual key. The “virtual key” is electronic data for enabling an external terminal including the user terminal 103 to control at least some of the functions of the vehicle 101, or to instruct a process to be executed, through communication. Note that the “vehicle” referred to here can be a combustible fuel-powered automobile, an electric automobile, a fuel-cell automobile, an automobile including a power generating unit employing an internal combustion engine, or the like.

The management server 102 accepts a usage request for using the cabin of the vehicle 101 from the user terminal 103, and when a determination is made to permit the cabin of the vehicle 101 to be used, sends a virtual key enabling a door of the vehicle 101 to be unlocked to the user terminal 103. Additionally, as will be described later, the management server 102 manages information of the vehicle 101, including usage permission information for determining whether to permit a user to use the vehicle 101, and determines whether or not to permit the vehicle 101 to be used on the basis of the usage request from the user terminal 103 and the usage permission information.

The user terminal 103 is a terminal, such as a smartphone, that is operated by a user wishing to use the cabin of the vehicle 101 or the owner of the vehicle 101. As one example, the user terminal 103 may also be installed in a parking lot.

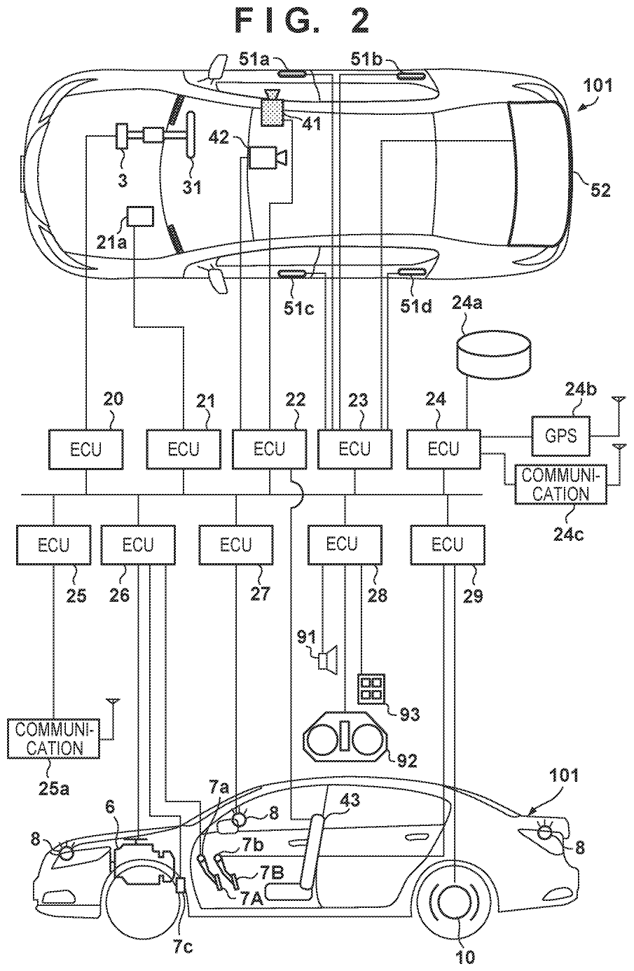

The configurations of the vehicle 101, the management server 102, and the user terminal 103 will be described hereinafter with reference to FIGS. 2 to 4.

Vehicle

FIG. 2 is a block diagram illustrating the vehicle 101 according to the present embodiment. An overview of the vehicle 101 is illustrated in FIG. 2, both as a plan view and as a side view. The vehicle 101 is, for example, a sedan-type four-wheeled passenger vehicle.

The vehicle 101 includes a control unit 2. The control unit 2 includes a plurality of ECUs 20 to 29, which are communicatively connected over an in-vehicle network. Each ECU includes a processor such as a CPU, a storage device such as semiconductor memory, an interface with external devices, and the like. The storage device stores programs executed by the processor, the data used in processing by the processor, and so on. Each ECU may include a plurality of processers, storage devices, interfaces, and so on.

Functions and the like handled by the ECUs 20 to 29 will be described hereinafter. Note that the number of ECUs, the functions handled by the ECUs, and so on can be set as desired, and can be set at a finer or broader level than that described in this example.

The ECU 20 controls an electric power steering device 3. The electric power steering device 3 includes a mechanism for turning the front wheels in response to a driver making a driving operation (turning operation) on a steering wheel 31. The electric power steering device 3 also includes a motor for assisting the turning operation or for producing drive power for automatically turning the front wheels, a sensor for detecting a steering angle, and the like.

The ECU 21 controls the strength and temperature of an air conditioner 21a. In FIG. 2, the air conditioner 21a blows air from a vent provided in a dashboard in an area in front of a driver's seat and a passenger seat, but air can also be blown to rear seats, through a defroster, or the like. The ECU 21 can also individually control a plurality of air conditioners 21a that blow air from corresponding individual vents, for example.

The ECU 22 controls detection units 41 to 43, which detect states within the cabin of the vehicle 101 or states in the surrounding area of the vehicle 101 and process information of detection results. The detection unit 41 is one or more cameras that capture the user of the vehicle 101 (also called an “outer camera 41” hereinafter), and in this example, is provided on top of the roof on the driver's seat-side of the vehicle 101. The user of the vehicle 101 can be identified by analyzing an image captured by the outer camera 41. Note that the outer camera 41 may be attached to a door of the vehicle 101, the top of the roof above the door, or the like as well. As another example, the outer camera 41 may be attached to the windshield, within the vehicle cabin, in an area corresponding to a forward part of the roof, and function as a dashcam. The detection unit 42 is a camera that captures the inside of the vehicle 101 (also called an “inner camera 42” hereinafter), and in this example, is provided on the windshield, within the vehicle cabin, in an area corresponding to a forward part of the roof of the vehicle 101. The number of occupants, the occupants themselves, and so on of the vehicle 101 can be identified by analyzing an image captured by the inner camera 42. The detection unit 43 is a sensor installed within the cabin of the vehicle 101 (also called a “cabin sensor 43” hereinafter), and in this example, is a seating sensor attached to a seat. The cabin sensor 43 may include a temperature sensor, a microphone, a pressure sensor, an infrared light sensor, or the like, for example.

The ECU 23 controls key units 51a to 52, which control the locking and unlocking of doors of the vehicle 101. The key units 51a to 52 may be capable of locking and unlocking the vehicle 101 using a virtual key or a physical key. A configuration is also possible in which all of the key units 51a to 52 can be locked and unlocked by a key belonging to the owner of the vehicle 101, whereas only some of the key units 51a to 51d can be locked and unlocked by a virtual key sent to a renter by the management server 102. In other words, the key units 51a to 52 can be controlled individually by the ECU 23. Additionally, the ECU 23 can instruct one or more of the ECUs to control operations on the basis of a received virtual key.

The ECU 24 controls a GPS sensor 24b and a communication unit 24c, and processes information of detection results or communication results. The GPS sensor 24b detects the current position of the vehicle 101. The communication unit 24c communicates wirelessly with a server that provides map information, traffic information, and the like, and obtains that information. The ECU 24 can access a map information database 24a provided in the storage device, and the ECU 24 can search for routes from the current location to a destination and the like. Note that the ECU 24 also communicates with the management server 102 via the communication unit 24c. The communication unit 24c is, for example, a communication device for communicating on the basis of a long-range wireless communication system such as a cellular network or satellite communication.

The ECU 25 includes a communication device 25a for short-range communication. The communication device 25a is a communication device for communicating compliant with a short-range wireless communication standard such as Wi-Fi or Bluetooth (registered trademark). Note that in the present embodiment, the vehicle 101 authenticates the virtual key by communicating with the user terminal 103 via the communication device 25a. In this case, the communication device 25a may transfer the virtual key received from the user terminal 103 to the ECU 23. As one example, the vehicle 101 may carry out vehicle-to-vehicle wireless communication with another nearby vehicle through the communication device 25a and exchange information with the other vehicle as well, for example.

The ECU 26 controls a power plant 6. The power plant 6 is a mechanism for outputting drive power that rotates drive wheels of the vehicle 101, and includes an engine and a transmission, for example. For example, the ECU 26 controls the output of the engine in response to a driving operation (an acceleration operation) made by the driver, detected by an operation detection sensor 7a provided in an accelerator pedal 7A, switches the gear range of the transmission on the basis of information such as the vehicle speed detected by a vehicle speed sensor 7c, and the like.

The ECU 27 controls lights (brake lamps, headlights, taillights, and the like), including directional indicators 8. In the example illustrated in FIG. 2, the directional indicators 8 are provided in a front area, a rear area, and on the door mirrors of the vehicle 101.

The ECU 28 controls an input/output device. The input/output device outputs information to the occupant and accepts the input of information from the occupant. A speaker 91 communicates information to the occupant using audio. A display device 92 communicates information to the occupant by displaying images. The display device 92 is disposed, for example, in front of the driver's seat, and constitutes an instrument panel and the like, for example. Although audio and a display are mentioned here, information may be communicated through vibrations, lights, or the like. The information may also be communicated using a combination of audio, a display, vibrations, and lights. Furthermore, the combinations may be varied, or the states of the notifications may be varied, in accordance with a level (e.g., a level of urgency) of the information to be communicated. An input device 93 is disposed in a position where the device can be operated by the driver, and is a group of switches for making instructions to the vehicle 101. However, an audio input device may be included as well. For example, the input device 93 is a car navigation system.

The ECU 29 controls a braking device 10, a parking brake (not shown), and the like. The braking device 10 is, for example, a disc brake device, provided in each of the wheels of the vehicle 101, which causes the vehicle 101 to decelerate or stop by applying resistance against the rotation of the wheels. The ECU 29 controls the operations of the braking device 10 in response to a driving operation (a braking operation) made by the driver, detected by an operation detection sensor 7b provided in a brake pedal 7B, for example. If the driving state of the vehicle 101 is automated driving, the ECU 29 controls the deceleration and stopping of the vehicle 101 by automatically controlling the braking device 10 in response to instructions from the ECU 20. The braking device 10, the parking brake, and the like can also be operated in order to keep the vehicle 101 in a stopped state. Furthermore, if the transmission of the power plant 6 is provided with a parking lock mechanism, that parking lock mechanism can also be operated in order to keep the vehicle 101 in a stopped state.

Management Server

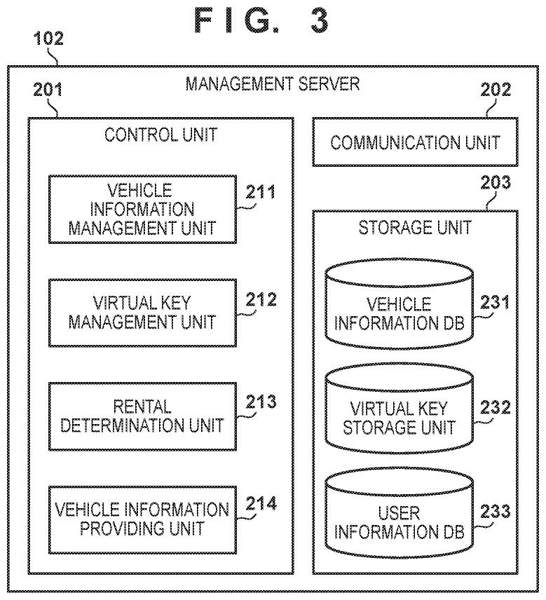

FIG. 3 is a block diagram illustrating the management server 102 according to the present embodiment. As illustrated in FIG. 3, the management server 102 includes a control unit 201, a communication unit 202, and a storage unit 203.

The control unit 201 includes a CPU and random access memory (RAM), and controls the management server 102 by executing various types of programs stored in the storage unit 203. By executing various types of programs, the control unit 201 functions as a vehicle information management unit 211, a virtual key management unit 212, and a rental determination unit 213. The control unit 201 also functions as a vehicle information providing unit 214 as needed.

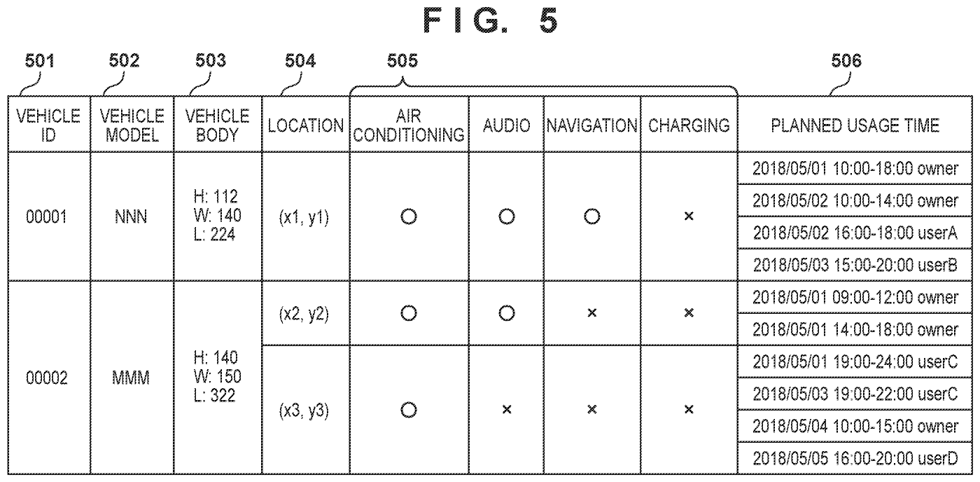

The vehicle information management unit 211 registers vehicle information in a vehicle information database (DB) 231, or updates registered vehicle information, on the basis of information received from the vehicle 101 or the user terminal 103 via the communication unit 202. The information stored in the vehicle information DB 231 will be described later with reference to FIG. 5.

The virtual key management unit 212 sends a virtual key, which is stored in a virtual key storage unit 232, to the user terminal 103. When the cabin of the vehicle 101 is to be rented out for individual time periods, the management server 102 can send the virtual key to the user terminal 103 along with information pertaining to the time period for which the vehicle 101 is to be rented out. Alternatively, the virtual key can be modified using the information pertaining to the time period for which the vehicle 101 is to be rented out. In this specification, “sending the virtual key including information pertaining to the time period for which the vehicle 101 is to be rented out” includes both a case where the information is sent along with or immediately after the virtual key, and a case where the virtual key is modified using that information. In other words, there are cases where the virtual key itself includes information pertaining to a time period in which that virtual key is valid. Likewise, the virtual key itself may include information pertaining to functions that are activated by that virtual key. Note that the virtual key management unit 212 may receive a virtual key for renting out the vehicle 101 from the user terminal 103 of the owner of the vehicle 101 or from the vehicle 101 and store that virtual key in the virtual key storage unit 232, or may generate the virtual key.

The rental determination unit 213 receives a usage request from the user terminal 103 via the communication unit 202. If it has been determined, on the basis of the information obtained by the vehicle information management unit 211, that a user is to be permitted to use the vehicle 101 for which the usage request was made, the rental determination unit 213 instructs the virtual key management unit 212 to send a virtual key for that vehicle to that user terminal.

The vehicle information providing unit 214 provides, to the user terminal 103 and the like, information pertaining to the vehicle 101 that can be used. As one example, the function of the vehicle information providing unit 214 may be realized by the vehicle information providing unit 214 functioning as a web server in order to communicate, to the user terminal 103, the information pertaining to the vehicle 101 that can be rented out (the usage permission information). In this case, the user terminal 103 can access the management server 102, receive the usage permission information of the vehicle, such as the time for which the vehicle 101 can be rented or the location of the vehicle 101, and provide that information to a user through an output I/F 304.

The communication unit 202 is a wired or wireless interface for communicating with the vehicle 101 and the user terminal 103. The storage unit 203 is a storage region constituted by a hard disk drive (HDD), and stores various types of programs, data, and the like. Additionally, the storage unit 203 includes the vehicle information DB 231, the virtual key storage unit 232, and a user information DB 233.

The vehicle information DB 231 stores vehicle information, including rental permission information through which the owner of the vehicle 101 permits the vehicle 101 to be rented. The virtual key storage unit 232 stores the virtual key of the vehicle 101 registered in the vehicle information DB 231. As one example, the virtual key of the vehicle 101 stored in the virtual key storage unit 232 can be different from a virtual key held by the owner of the vehicle 101. For example, the virtual key for rental may be a one-time key, whereas the virtual key held by the owner need not be a one-time key. The virtual keys stored in the virtual key storage unit 232 may be only the virtual key for renting the vehicle cabin, or the virtual key used by the owner may also be stored. A user information DB 233 stores information of the user using the management system 100 (the renter) and information of the owner of the vehicle 101 managed by the management system 100.

User Terminal

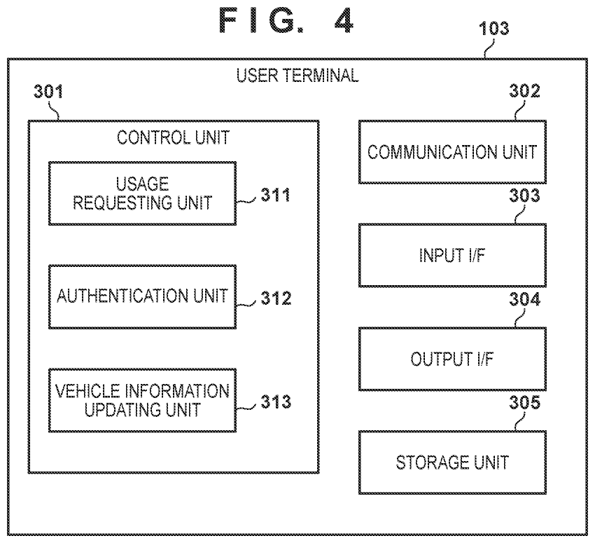

FIG. 4 is a block diagram illustrating the user terminal 103 according to the present embodiment. As illustrated in FIG. 4, the user terminal 103 includes a control unit 301, a communication unit 302, an input interface (I/F) 303, the output I/F 304, and a storage unit 305. The user terminal 103 also includes a GPS sensor (not shown) as needed.

The control unit 301 includes a CPU and RAM, and controls the user terminal 103 by executing various types of programs stored in the storage unit 305. The control unit 301 realizes the functions of a usage requesting unit 311, an authentication unit 312, and a vehicle information updating unit 313 by executing the various types of programs.

The usage requesting unit 311 sends the usage request for the vehicle 101 to the management server 102 via the communication unit 302, and stores the virtual key for the vehicle 101, sent from the management server 102, in the storage unit 305. The authentication unit 312 communicates with the vehicle 101 via the communication unit 302, and executes authentication for requesting the vehicle 101 to be unlocked using the virtual key stored in the storage unit 305.

If the user of the user terminal 103 owns the vehicle 101, the vehicle information updating unit 313 receives, via the input I/F 303, information pertaining to the time period for which that vehicle 101 is to be rented, and sends that information to the management server 102. In this case, the owner of the vehicle 101 may input the location of the vehicle 101 in order to rent out the vehicle 101. For example, to rent out the cabin of the vehicle 101 at a location different from the location of the vehicle 101 at that point in time, the owner of the vehicle 101 may send information pertaining to the rental location to the management server 102 in addition to the time period for which the vehicle 101 is to be rented out. Additionally, when the vehicle 101 has been unlocked by the authentication unit 312 of the user terminal 103 belonging to the user wishing to use the vehicle cabin, the user of the user terminal 103 sends an indication that he/she will start using the vehicle 101 to the management server 102.

The communication unit 302 is a wired or wireless interface for communicating with the vehicle 101 and the user terminal 103. The input I/F 303 is an interface for accepting user operations, and includes at least one of a mouse, keyboard, a microphone, or the like. The output I/F 304 is an interface for making outputs to the user, and includes at least one of a display, a speaker, or the like. For example, the input I/F 303 and the output I/F 304 can be formed integrally as a touch screen.

In addition to the various types of programs for controlling the user terminal 103, the storage unit 305 stores the virtual key received from the management server 102. As one example, the user terminal 103 includes a GPS sensor (not shown), and measures the current position of the user terminal 103. The usage requesting unit 311 can send a usage request including position information obtained from the GPS sensor to the management server 102.

Here, an example of the information stored in the vehicle information DB 231 will be described with reference to FIG. 5. A vehicle identifier (ID) 501, a vehicle model 502, a vehicle body 503, a location 504, functions 505, and a planned usage time 506 are held in the vehicle information DB 231. The vehicle ID 501 is an identifier assigned to each vehicle 101 managed by the management server 102. The vehicle model 502 is information pertaining to the model of the vehicle 101. The vehicle body 503 is information pertaining to the body of the vehicle 101, and in the present embodiment, is information pertaining to the size of the vehicle cabin. As one example, the vehicle body 503 can include information pertaining to the intended occupancy. The location 504 is information pertaining to the current location of the vehicle 101. As one example, the location 504 can be location information measured by the GPS sensor 24b of the vehicle 101 and received by the management server 102 from the vehicle 101.

The functions 505 are functions which the owner of the vehicle 101 permits the user to use when renting the vehicle cabin. For example, in FIG. 5, the functions 505 include air conditioning, audio, navigation, and charging. If, for example, air conditioning can be used, the vehicle 101 allows the function of the ECU 21 to be used when the vehicle 101 has been unlocked with the virtual key. A method by which the vehicle 101 limits the functions that can be used will be described later. As one example, the functions 505 can include information pertaining to services that can be provided by the vehicle 101, separate from the functions of the vehicle itself, such as whether or not smoking is permitted, the availability of amenities, and the like.

The functions 505 may be expressed as “applications” instead. For example, applications to be permitted for the vehicle 101, such as “emergency shelter”, “listening to music”, and “rest”, may be set by the owner of the vehicle 101. “Emergency shelter” includes a sudden usage request for the vehicle cabin, such as when sheltering from the rain, a suspicious person, or the like. If the usage application of the vehicle 101 can be set in the vehicle information DB 231, the air conditioning, audio, and navigation functions may be usable when the application is “listening to music”, whereas only the air conditioning function may be made usable when the application is “rest”, for example.

The functions 505 may also include conditions that change depending on the state of the vehicle 101. For example, if the vehicle 101 is an electric automobile, the air conditioning and audio may be permitted to be used as long as the remaining battery charge is greater than or equal to 60%, and only the air conditioning may be permitted to be used when the remaining battery charge is less than 60%. Alternatively, if the vehicle 101 is being charged, the air conditioning, audio, and navigation may be permitted to be used, whereas if the vehicle 101 is not being charged, only the air conditioning may be permitted to be used.

The planned usage time 506 is a time at which the owner or renter of the vehicle 101 plans to use the vehicle 101, and in FIG. 5, is saved as a username of the user planning to use the vehicle (owner, userA, userB, or the like). Note that if the vehicle 101 requests a rental fee from the renter, information pertaining to the rental fee may be additionally stored in the vehicle information DB 231.

The functions 505 need not be taken into consideration when the owner of the vehicle 101 uses the vehicle 101. In other words, the owner of the vehicle 101 can use the vehicle 101 for travel. Accordingly, the vehicle cabin can be rented out at different locations depending on the time period, as with the vehicle having a vehicle ID 501 of 00002. Even in this case, obtaining a planned location of the vehicle 101 along with the owner's planned usage time makes it possible to rent out the cabin of the vehicle 101 at the planned location in time periods where the owner is not using the vehicle 101.

### Processing Example

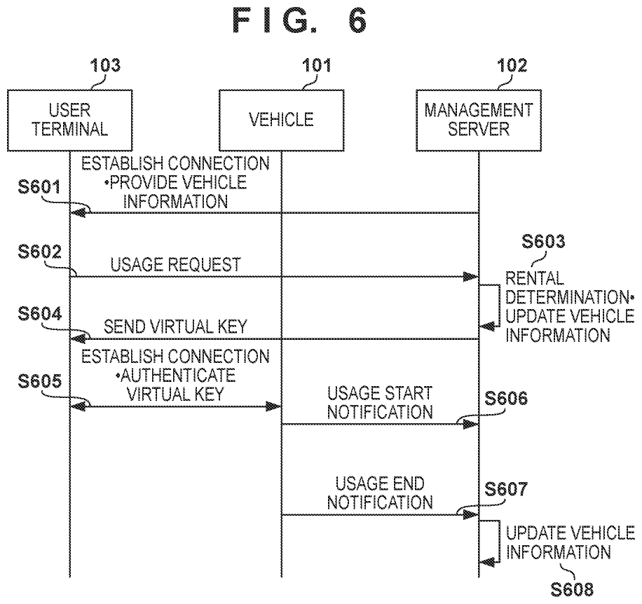

Next, the flow of a rental process executed by the management system constituted by the vehicle 101 and the management server 102, and the user terminal 103 of the renter, will be described with reference to FIG. 6.

First, in step S601, the management server 102 establishes a connection with the user terminal 103, and provides the vehicle information. Although the present embodiment describes the process of step S601 as being started in response to the user terminal 103 accessing the management server 102, the management server 102 may periodically execute the process of step S601. In such a case, the management server 102 can provide the vehicle information to the user terminal 103 using email or the like. Additionally, the vehicle information may include information pertaining to a plurality of vehicles 101. Furthermore, the vehicle information may include information pertaining to the rental fee for using the vehicle 101.

Having received the vehicle information, the user terminal 103 provides at least some of the vehicle information to the user. Once the user has selected the vehicle 101 and entered information pertaining to the time period in which he/she wishes to use the vehicle 101, in step S602, the user terminal 103 sends a usage request for the selected vehicle 101 to the management server 102. As one example, when the user selects the vehicle 101 and enters a function he/she wishes to use, the user terminal 103 includes the function the user plans to use in the usage request. Having received the usage request, the management server 102 moves the process to step S603.

In step S603, the management server 102 determines whether or not to rent out the vehicle 101 which is to be used and is included in the usage request, on the basis of information pertaining to the time period in which the user wishes to use the vehicle 101. As one example, the management server 102 can permit the vehicle 101 to be rented by sending an email to the owner or a managing user of the vehicle 101. In such a case, the vehicle information DB 231 can store contact information of the owner or managing user corresponding to the vehicle 101 in the user information DB 233. If it has been determined that the vehicle 101 is to be rented out, planned usage time information indicating that the user will use the vehicle 101 in the time period included in the usage request is stored in the vehicle information DB 231. As one example, billing information of the user who uses the vehicle 101 may be stored in the user information DB 233.

Next, in step S604, the management server 102 sends a virtual key to the user terminal 103. Here, the planned usage time, information pertaining to the functions the user plans to use, and so on may be sent along with the virtual key. Additionally, as described above, the virtual key may be generated including the planned usage time, the functions the user plans to use, or information pertaining to the user, and may then be sent to the user terminal 103. As another example, the management server 102 can send information pertaining to the vehicle 101, such as information pertaining to the license plate, to the user terminal 103 in step S604. As yet another example, the management server 102 may send information pertaining to the functions the user plans to use to the vehicle 101 in step S604. Alternatively, in step S604, the management server 102 may send a virtual key to the user terminal 103, and may also send, to the vehicle 101, a virtual key for authentication or information pertaining to the planned usage time or the functions the user plans to use.

The user of the user terminal 103 that has received the virtual key in step S604 establishes a connection with the vehicle 101 in step S605, and allows the ECU 23 of the vehicle 101 to authenticate the virtual key. Upon authenticating a virtual key for rental, the vehicle 101 unlocks at least one of the key units 51a to 52. Along with unlocking the doors of the vehicle 101, the ECU 23 can also instruct other ECUs to provide functions. However, the power plant 6, the braking device 10, or the accelerator pedal 7A may be prohibited from operating so that the vehicle 101 does not move, even when the virtual key for rental is used. Alternatively, the ECUs may not accept user operations of the power plant 6, the braking device 10, or the accelerator pedal 7A. In other words, the virtual key for rental enables at least one of the doors of the vehicle 101 to be unlocked or locked, but does not activate at least some of the functions of the vehicle 101.

As one example, the outer camera 41 may be operated so as to obtain image information for identifying the user using the vehicle 101. In such a case, for example, the vehicle 101 may send the image information of the user to the management server 102, and by comparing that image information with a user image stored in the user information DB 233, the management server 102 may determine whether the user of the vehicle cabin matches the user in the user image. Alternatively, if, on the basis of the image information obtained by the outer camera 41, it is determined that the number of users included in the usage request differs from the actual number of users, the vehicle 101 may notify the user or the management server 102 that the number of users is different.

As another example, the inner camera 42 may be operated to permit the vehicle cabin to be used only if it is determined that no one is present in the cabin of the vehicle 101. Once the virtual key authentication is complete and the user starts using the cabin of the vehicle 101, in step S606, the vehicle 101 notifies the management server 102 that the user has actually started using the cabin of the vehicle 101.

Once the user has finished using the cabin of the vehicle 101, in step S607, the vehicle 101 notifies the management server 102 that the usage has stopped. Here, the vehicle 101 can detect that the user has stopped using the vehicle cabin by receiving information indicating that the usage has stopped from the user terminal 103 after the planned usage time has passed, or by detecting that the key units 51a to 52 have been locked. As one example, the user terminal 103 may communicate information indicating that the usage has ended to the management server 102 in addition to, or instead of, the notification from the vehicle 101 to the management server 102.

Here, in step S607, the vehicle 101 may measure a change in the state of the vehicle cabin between before and after the user has used the vehicle 101, by using the inner camera 42, a sensor (not shown), or the like. For example, if the inner camera 42 or the sensor detects that the user has soiled the cabin of the vehicle 101, forgotten an item, or damaged the vehicle cabin, at least one of the user, the management server 102, the owner of the vehicle 101, and an administrator can be notified. In this manner, the user can be cautioned to return the cabin of the vehicle 101 to the state from before the cabin was used, and the management server 102 can bill a user or the like an additional fee for damaging equipment provided in the vehicle cabin.

Note that the vehicle 101 need not permit another user who has a virtual key and the owner who has a physical key to unlock the vehicle 101 from the notification that the usage is starting in step S606 to the notification that the usage has ended in step S607. This prevents problems from arising between users of the vehicle 101, and makes it possible for the user to use the cabin of the vehicle 101 safely with respect to other users. However, the vehicle 101 may allow the vehicle 101 to be unlocked using a virtual key or a physical key under predetermined conditions. The “predetermined conditions” include, for example, when a temperature sensor (not shown) within the vehicle cabin, an accelerometer (not shown), or the like has detected an abnormal value. This makes it possible to unlock the vehicle 101 if there is a risk that the user of the vehicle cabin will damage the vehicle cabin. Alternatively, the “predetermined conditions” include the planned usage time passing without a notification that the usage has ended in step S607. This makes it possible to unlock the vehicle 101 after the planned usage time has passed, such as in situations where the user of the vehicle cabin has fallen asleep or lost consciousness.

Having received the notification that the usage has ended in step S607, the management server 102 moves the process to step S608, and updates the vehicle information. Here, the management server 102 may store the billing information of the user who used the vehicle 101 in the user information DB 233. The management server 102 may request different usage fees from the user depending on the usage time, the usage application, the amount of time from when the usage request was made to when the vehicle 101 was used, and so on.

According to the management system of the present embodiment as described thus far, when a usage request is received from the user terminal of a renter of the vehicle, a virtual key that permits a door of the vehicle to be unlocked and the renter to enter the vehicle, but prohibits the use of at least some of the functions of the vehicle, is sent. This makes it possible to rent out the cabin of a parked vehicle to a third party.

### Second Embodiment

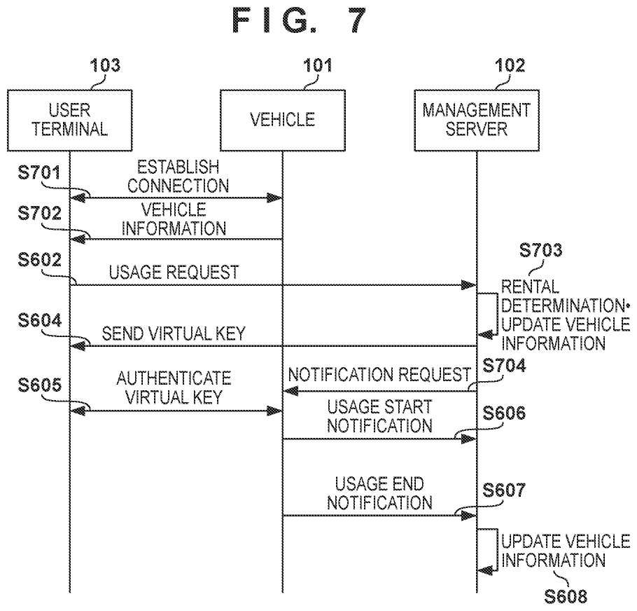

In the first embodiment, when renting out a vehicle, the management server determines to rent out the vehicle upon receiving approval from the owner of the vehicle. As one example, the management server may determine whether or not to rent out the vehicle so that, for example, the vehicle is rented out when the user does not plan to use the vehicle in a time period in which the user has requested usage. The present embodiment will describe an example of a rental process executed by the management system with reference to FIG. 7. Descriptions of configurations or processes identical to those in the first embodiment will be omitted.

The present embodiment assumes that the user wishes to use the vehicle 101 for emergency shelter from rain, a suspicious person, or the like. In such a case, it is necessary for the renter to find a usable vehicle 101 parked nearby as quickly as possible.

First, in step S701, the user terminal 103 establishes a connection with a nearby vehicle 101 via the communication unit 302. As one example, the communication unit 302 establishes a connection with the vehicle 101 through near-field communication compliant with the Wi-Fi standard. As another example, after establishing the connection, the user terminal 103 may notify the vehicle 101 that the user wishes to use the vehicle cabin for emergency shelter. Having detected that a connection has been established, the vehicle 101 sends the vehicle information to the user terminal 103 in step S702. Here, the vehicle information sent to the user terminal 103 from the vehicle 101 includes at least the vehicle ID. The present embodiment assumes that when another user is already using the cabin of the vehicle 101, the vehicle 101 does not send the vehicle information in step S702. However, as one example, the vehicle 101 need not send the vehicle information in step S702 if the functions of that vehicle 101 that are permitted to be used have been received from the vehicle information DB 231 of the management server 102 in advance and the use of the vehicle 101 for emergency shelter is not permitted.

Having received the vehicle information in step S702, the user terminal 103 sends the usage request to the management server 102 in step S602. Here, the usage request need not include information pertaining to the time period for which the user wishes to use the vehicle or a function the user wishes to use. Alternatively, in the case of emergency shelter, the request may be sent to the management server 102 so as to use a predetermined amount of time (e.g., 15 minutes or 30 minutes) or a predetermined function (e.g., only air conditioning). Having received the usage request, the management server 102 makes a rental determination in step S703. The management server 102 determines whether or not to rent out the vehicle 101 which is to be used and is included in the usage request, on the basis of information pertaining to the time period in which the user wishes to use the vehicle 101. As one example, the management server 102 may allow the renter to use the vehicle 101 included in the usage request if no planned usage time is registered within a predetermined amount of time in the vehicle information DB 231. Steps S604 to S608 execute the same processes as in the first embodiment and will therefore not be described here.

Note that the management server 102, which has sent the virtual key in step S604, may send a notification request in step S704, so as to notify the user outside the vehicle, by flashing the directional indicators 8 to help the user identify the vehicle. Alternatively, the vehicle 101 may notify the user that the key authentication has succeeded in step S605. Additionally, when the virtual key has been received in step S604, or when the virtual key authentication has succeeded in step S605, the user terminal 103 may output a message for prompting the occupant to the user through the output I/F 304.

As another example, the vehicle 101 may, for example, use the speaker 91 illustrated in FIG. 2 to announce a limitation on the usable time or the usage fee to the user who has started to use the vehicle cabin in step S606. Additionally, in step S608, the management server 102 may bill the user who has taken emergency shelter at a higher rate. As another example, the management server 102 may discount the usage fee if there is a history of notifying the police, weather information, a photo taken from inside the car, or the like.

According to the management system of the present embodiment as described thus far, the management server determines whether or not to rent out a vehicle in response to a usage request from a renter. Accordingly, whether or not to rent out the vehicle to the renter can be determined in a shorter amount of time than when receiving approval from the owner of the vehicle.

### Third Embodiment

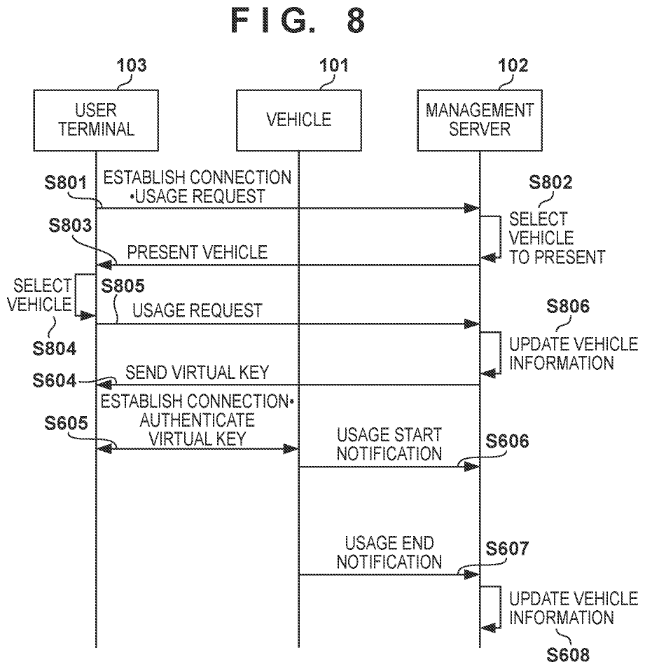

In the first embodiment, the management server determines whether to permit a renter to use a designated vehicle. However, as one example, the renter may specify conditions for vehicles he/she wishes to rent, and the management server may then present one or more vehicles to the user on the basis of the specified conditions. The present embodiment will describe an example of a rental process executed by the management system with reference to FIG. 8. Descriptions of configurations or processes identical to those in the first embodiment will be omitted.

In step S801, the user terminal 103 establishes a connection with the management server 102, and sends conditions desired by the user. As one example, if the management server 102 functions as a web server, the conditions can be specified through a web service provided by the management server 102. Alternatively, the conditions may be specified through an application running on the user terminal 103. Here, the conditions desired by the user may be the model, vehicle body, functions, or the like, for example. If “vehicle body” is included in the conditions, for example, a “vehicle having a cabin length of 300 cm or more” can be specified, whereas if “functions” are included in the conditions, a “vehicle in which audio can be used” can be specified. The time period for which usage is desired, the usage fee, and the like can also be included in the conditions desired by the user.

In step S802, the management server 102 selects a vehicle to present, which matches the usage conditions desired by the user, received from the user terminal 103. For example, if the user has send a usage condition of “vehicle cabin length is 300 cm or more” to the management server 102 including the vehicle information DB 231 that stores the vehicle information indicated in FIG. 5, the management server 102 can send information pertaining to the vehicle ID 501 of 00002. Here, the vehicle having a vehicle ID 501 of 00002 is parked at a location 504 of (x2,y2), and if the owner of the vehicle (the user “owner”) is not using the vehicle, it is determined that the vehicle can be used, and the vehicle to present is selected. Note that the management server 102 may take the user information of the renter into consideration when selecting the vehicle to present. For example, the owner of the vehicle 101 may be able to set a user who has damaged the vehicle 101 when using the vehicle in the past as a prohibited user, and not permit prohibited users to use that vehicle 101 or a plurality of vehicles 101 owned by that owner.

Next, the management server 102 moves the process to step S803, where information of the vehicle to be presented is sent to the user terminal 103. Here, in addition to information pertaining to the usable location, time period, and so on of the vehicle 101, the management server 102 may also send additional information such as usage fees to the user terminal 103. Note that the information of the vehicle to be presented sent by the management server 102 may include information of two or more vehicles to be presented.

Having received the information of the vehicle to be presented, in step S804, the user terminal 103 selects the presented conditions, such as the vehicle to be used, the time period, the functions, or the location, and generates a usage request including those conditions. Next, in step S805, the user terminal 103 sends the generated usage request to the management server 102. Having received the usage request, in step S806, the management server 102 updates the vehicle information DB 231 using the information pertaining to the planned usage by the user, included in the usage request. The processes of steps S604 to S608 are the same as in the first embodiment, and thus descriptions thereof will be omitted.

As one example, steps S803 to S805 may be omitted. For example, in step S801, the user terminal 103 may send a usage request along with the usage conditions. In such a case, the management server 102 may select one vehicle 101 to present in step S802 and send the virtual key of that vehicle 101 in step S604.

According to the management system of the present embodiment as described thus far, the usage request includes conditions including at least one of a time, a function, a vehicle body, a location, and an application desired by a renter. Accordingly, the management system can present suitable vehicle to the renter.

### Other Embodiments

The above-described first to third embodiments can be combined as appropriate. For example, the management server according to the third embodiment may send a notification request such as that described in the second embodiment so that a user outside the car is notified using lights or the like so that he/she can easily identify the vehicle he/she will use.

In one embodiment, the vehicle 101 may be capable of ascertaining the state of the vehicle before and after the user uses the vehicle cabin, by using a sensor. For example, the inner camera 42 and the sensor 43 may obtain data of the vehicle 101, and the magnitude of a change in the state of the vehicle cabin may be determined after the user finishes using the vehicle cabin. Then, if it is determined that the change in the state of the vehicle cabin is outside a predetermined range, the vehicle 101 notifies at least one of the user who used the vehicle cabin, the management server 102, the owner of the vehicle 101, and an administrator that the state of the vehicle cabin has changed between before and after the usage. This makes it possible to detect activity that damages the vehicle 101 or the like. Additionally, when it is determined that the change in the state of the vehicle cabin between before and after the user has used the vehicle cabin is outside the predetermined range, the vehicle 101 can control the key units 51a to 52 or the like to prevent the user from exiting the vehicle, permit the user to exit the vehicle only after cleaning the vehicle cabin, and so on. This makes it possible to reduce the need for vehicle cabin upkeep on the part of the owner of the vehicle 101 or a manager. Additionally, even if the user is currently using the vehicle cabin, the vehicle 101 may obtain data using the inner camera 42 and the sensor 43 if predetermined conditions such as an announcement being made through the speaker being satisfied.

In one embodiment, the management server 102 may be installed in the vehicle 101. In other words, at least some of the functions of the management server 102 may be realized by an ECU of the vehicle 101. This makes it possible to reduce the processing load on the management server.

### Summary of Embodiments

1. A management server according to the above-described embodiments is a management server (e.g., 102) that manages a vehicle (e.g., 101), the server including: a receiving unit (e.g., 202) configured to receive a usage request for the vehicle from a user terminal (e.g., 103) of a renter; and a sending unit (e.g., 212) configured to send, to the user terminal, a virtual key that enables the vehicle to be used, wherein the virtual key is a key that permits a door of the vehicle to be unlocked and permits the renter to enter the vehicle, and prohibits at least some of other functions of the vehicle from being used.

This makes it possible to rent out the cabin of a parked vehicle to a third party.

2. In the management server according to the above-described embodiments, the other functions of the vehicle include vehicle travel.

This makes it possible to allow usage of the vehicle cabin only.

3. The management server according to the above-described embodiments further includes: a managing unit (e.g., 231) configured to manage usage permission information for a third party with respect to the vehicle; and a selecting unit (e.g., 213) configured to select a vehicle to permit to be used, on the basis of the usage request and the usage permission information, wherein the sending unit sends the virtual key of the vehicle selected by the selecting unit.

This makes it possible for the management server to manage and rent out a plurality of vehicles.

4. In the management server according to the above-described embodiments, the usage permission information includes information pertaining to the vehicle body of the vehicle; and the usage request includes information pertaining to a vehicle body desired by the renter.

This makes it possible for the management server to select the vehicle to rent out to the renter from the standpoint of the body of the vehicle.

5. In the management server according to the above-described embodiments, the usage permission information includes information pertaining to an unused time of the vehicle; and the usage request includes information pertaining to a planned usage time of the renter.

This makes it possible for the management server to select the vehicle to rent out to the renter from the standpoint of the usage time.

6. In the management server according to the above-described embodiments, the usage permission information includes information pertaining to a function of the vehicle that can be used; and the usage request includes information pertaining to a function desired by the renter.

This makes it possible for the management server to select the vehicle to rent out to the renter from the standpoint of the function.

7. In the management server according to the above-described embodiments, the usage permission information includes location information of the vehicle; and the usage request includes information pertaining to a current location or planned usage location of the renter.

This makes it possible for the management server to select the vehicle to rent out to the renter from the standpoint of the location of the vehicle.

8. In the management server according to the above-described embodiments, the virtual key is a virtual key for which a usage time of the vehicle is limited.

This makes it possible to limit the usage time of the vehicle using the virtual key.

9. In the management server according to the above-described embodiments, the virtual key includes information pertaining to a function permitted to be used by the renter.

This makes it possible to limit the functions of the vehicle using the virtual key.

10. A management system according to the above-described embodiments is a management system (e.g., 100) including a vehicle (e.g., 101) and a management server (e.g., 102) that manages the vehicle, wherein the management server includes: a receiving unit (e.g., 202) configured to receive a usage request for the vehicle from a user terminal (e.g., 103) of a renter; and a sending unit (e.g., 212) configured to send, to the user terminal, a virtual key that enables the vehicle to be used, and the vehicle includes a control unit configured to permit a door of the vehicle to be unlocked by the virtual key and prohibits at least some of other functions of the vehicle from being used by the virtual key.

This makes it possible to rent out the cabin of a parked vehicle to a third party.

11. In the management system according to the above-described embodiments, the vehicle includes a sensor (e.g., 42, 43) capable of ascertaining a state within the vehicle cabin.

This makes it possible for the management system to ascertain the state inside the vehicle cabin.

12. In the management system according to the above-described embodiments, the vehicle ascertains the state within the vehicle cabin using the sensor before and after use by the renter.

This makes it possible to recommend maintenance if the state inside the vehicle cabin has changed significantly.

13. In the management system according to the above-described embodiments, the vehicle includes a restricting unit configured to restrict the control unit from allowing the renter to exit the vehicle after a change in the state within the vehicle cabin has been determined to be outside a predetermined range between before and after the use by the renter.

This makes it possible to prompt the renter to clean the vehicle cabin cleaning if the renter has soiled the vehicle cabin.

14. In the management system according to the above-described embodiments, the control unit permits the renter to enter the vehicle when the vehicle cabin is determined to be unoccupied.

This makes it possible to permit the vehicle cabin to be used only when the vehicle cabin is not already in use.

15. In the management system according to the above-described embodiments, the control unit does not permit the vehicle to be unlocked by a key carried by an owner of the vehicle while the renter is using the vehicle.

As a result, parties aside from the renter, including the owner of the vehicle, cannot enter the vehicle, and thus the renter can use the vehicle cabin safely.

16. In the management system according to the above-described embodiments, the vehicle includes a camera (e.g., 41) capable of capturing an image outside the vehicle; and an image of the renter is captured before the renter uses the vehicle.

This makes it possible to confirm that the renter matches the actual user.

17. In the management system according to the above-described embodiments, the vehicle makes a notification outside the vehicle when the vehicle has been unlocked by the renter.

This makes it possible for the renter to easily identify the vehicle he/she will use.

18. A management method according to the above-described embodiments is a management method carried out by a management server that manages a vehicle, the method including: receiving (e.g., S602, S805) a usage request for the vehicle from a user terminal of a renter; and sending (e.g., S604), to the user terminal, a virtual key that enables the vehicle to be used, wherein the virtual key is a key that permits a door of the vehicle to be unlocked and permits the renter to enter the vehicle, and prohibits at least some of other functions of the vehicle from being used.

This makes it possible to rent out the cabin of a parked vehicle to a third party.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A management server that manages a vehicle, the server comprising:
a receiving unit configured to receive a usage request for the vehicle from a user terminal of a renter; and
a sending unit configured to send, to the user terminal, a virtual key that enables the vehicle to be used,
wherein the virtual key is a key that permits a door of the vehicle to be unlocked and permits the renter to enter the vehicle, and prohibits at least some of other functions of the vehicle from being used.

2. The management server according to claim 1,
wherein the other functions of the vehicle include vehicle travel.

3. The management server according to claim 1, further comprising:
a managing unit configured to manage usage permission information for a third party with respect to the vehicle; and
a selecting unit configured to select a vehicle to permit to be used, on the basis of the usage request and the usage permission information,
wherein the sending unit sends the virtual key of the vehicle selected by the selecting unit.

4. The management server according to claim 3,
wherein the usage permission information includes information pertaining to the vehicle body of the vehicle; and
the usage request includes information pertaining to a vehicle body desired by the renter.

5. The management server according to claim 3,
wherein the usage permission information includes information pertaining to an unused time of the vehicle; and
the usage request includes information pertaining to a planned usage time of the renter.

6. The management server according to claim 3,
wherein the usage permission information includes information pertaining to a function of the vehicle that can be used; and
the usage request includes information pertaining to a function desired by the renter.

7. The management server according to claim 3,
wherein the usage permission information includes location information of the vehicle; and
the usage request includes information pertaining to a current location or planned usage location of the renter.

8. The management server according to claim 1,
wherein the virtual key is a virtual key for which a usage time of the vehicle is limited.

9. The management server according to claim 1,
wherein the virtual key includes information pertaining to a function permitted to be used by the renter.

10. A management system comprising a vehicle and a management server that manages the vehicle,
wherein the management server comprises:
a receiving unit configured to receive a usage request for the vehicle from a user terminal of a renter; and
a sending unit configured to send, to the user terminal, a virtual key that enables the vehicle to be used, and
the vehicle comprises a control unit configured to permit a door of the vehicle to be unlocked by the virtual key and prohibits at least some of other functions of the vehicle from being used by the virtual key.

11. The management system according to claim 10,
wherein the vehicle includes a sensor capable of ascertaining a state within the vehicle cabin.

12. The management system according to claim 11,
wherein the vehicle ascertains the state within the vehicle cabin using the sensor before and after use by the renter.

13. The management system according to claim 11,
wherein the vehicle includes a restricting unit configured to restrict the control unit from allowing the renter to exit the vehicle after a change in the state within the vehicle cabin has been determined to be outside a predetermined range between before and after the use by the renter.

14. The management system according to claim 11,
wherein the control unit permits the renter to enter the vehicle when the vehicle cabin is determined to be unoccupied.

15. The management system according to claim 10,
wherein the control unit does not permit the vehicle to be unlocked by a key carried by an owner of the vehicle while the renter is using the vehicle.

16. The management system according to claim 10,
wherein the vehicle includes a camera capable of capturing an image outside the vehicle; and
an image of the renter is captured before the renter uses the vehicle.

17. The management system according to claim 10,
wherein the vehicle makes a notification outside the vehicle when the vehicle has been unlocked by the renter.

18. A management method carried out by a management server that manages a vehicle, the method comprising:
receiving a usage request for the vehicle from a user terminal of a renter; and
sending, to the user terminal, a virtual key that enables the vehicle to be used,
wherein the virtual key is a key that permits a door of the vehicle to be unlocked and permits the renter to enter the vehicle, and prohibits at least some of other functions of the vehicle from being used.
